(19) United States
(12) Patent Application Publication
(10) Pub. No.: US 2016/0193714 A1
(43) Pub. Date: Jul. 7, 2016

(54) PORTABLE SYSTEM FOR COLLECTING A DUST FROM A DUST PRODUCING MACHINE

(71) Applicant: 3M INNOVATIVE PROPERTIES COMPANY, Saint Paul, MN (US)

(72) Inventors: Naveen Machama, New Delhi (IN); Raju Bikram Singh Thakur, Bangalore (IN); Murthy Venkata Narayana Arelekatti, Bangalore (IN)

(21) Appl. No.: 14/915,723

(22) PCT Filed: Aug. 27, 2014
(86) PCT No.: PCT/US14/52823

§ 371 Date: Mar. 1, 2016

(30) Foreign Application Priority Data
Sep. 2, 2013 (IN) 3928/CHE/2013

(51) Int. Cl. B24B 55/10; B01D 46/00; B01D 50/00; B23Q 11/00; B01D 45/16

(52) U.S. Cl. CPC B24B 55/10; B23Q 11/0046; B01D 45/16; B01D 50/002; B01D 46/0041

(57) ABSTRACT

A portable system (200) for collecting a dust from one or more dust producing devices or arrangement (204A-B) is provided. The portable system includes a compressed air generating unit (202) for generating compressed air, a venturi unit (206) which is configured to connect the compressed air generating unit and at least one of the one or more dust producing devices or arrangement and a cyclone separator (212) which is connected to the venturi unit. The venture unit creates a suction using the compressed air. The suction collects the dust from the one or more dust producing machines and mixes the compressed air and the dust. The cyclone separator receives the dust and the compressed air and releases the compressed air by separating the dust.

### FIELD OF THE INVENTION

The present invention generally relates to a system for collecting a dust flowing from a dust producing device or work arrangement, and more particularly, but not exclusively, to the portable system for collecting the dust flowing from the one or more dust producing device or work arrangement with minimum filters and without the need of electric power and sensors.

### BACKGROUND OF THE INVENTION

In general, the machine used for cleaning or polishing the floors and the wood working machines, such as sanders, joiners, and the like are produces a more dust and those machines are called as dust producing Device or work arrangement. The floor cleaning or polishing machine produces fine particulate matter or dust, which tend to be driven upwards from the surface being cleaned or polished, due to the interaction of the surface being treated with the machine used in such operations. Further, the wood working machines produce the wood dust that is removed from a work-piece. Hence, the dust produced from the dust producing device or work arrangement has to be collected and removed from the work Place so as to avoid workplace hygiene & cleanness.

FIG. 1 illustrates a typical dust collection system 100. The typical dust collection system 100 includes an air compressor 102, a dust producing machine 104, an electrical motor 106 and a dust bag 108. The electric motor 106 and an air compressor 102 are used to collects the dust from the work piece and transfers to the dust bag 108. The dust bag 108 filters the dust and releases the fresh air outside. Alternatively, the electric motor 106 can be replaced by a blower or a fan to perform the same operation. The typical dust collection system 100 also includes a sensor (not shown in FIG. 1) which is attached to the electric motor 106 for controlling the operation of the electric motor 106 according to various condition. Hence due to the incorporation of electrical components 106 (e.g. motor), sensors and the dust bag 108 in the system increases the manufacturing cost. Further, the electrical components 106 inside the typical dust collection system 100 need to be serviced often which is cumbersome. Alternative approach is to connect the dust producing machine 104 with a filter bag arrangement to draw off the dust that is generated by the machines. The filter bag arrangement receives air that is carrying the dust from the dusting producing machine 104 and separates the air and dust using one or more filters. This alternative approach is inefficient and also not cost effective due to number of filters. Further, the typical dust collection system 100 is not portable system and occupies more space due to number of components in the system. The typical dust collection system 100 is not capable of collecting the dust from the one or more dust producing devices simultaneously. For example (Hand Blocks). In order to have extraction for hand blocks the device has to run continuous on power which can lead to burning of motor or either malfunctioning of sensors & electric circuits)

The typical electric dust collection system 100 is expensive and has more maintenance inefficiency. The current users of the typical electric dust collection system 100 face challenge like burning of Motors, malfunctioning of sensors, cleaning of dust bags, carbon bushes wear out, unavailability of spare parts. Those challenges lead to the down time of the machine which customer is not accepting at all. Also the cost of Equipment is a challenge to existing user. Trained manpower to handle this equipment remains a big challenge for Automotive Aftermarket business. The cost of the typical electric dust collection system 100 in the market is huge and cannot be affordable for the small & medium scale industries and the normal user. Most of the customers are feeling reluctant to use the typical electric dust collection system 100 due to its higher cost and maintenance inefficiency.

Accordingly there is a need in the art to provide a solution to one or more of above said problems. The present invention solves one or more of these problems in a unique and economical manner.

### SUMMARY OF THE INVENTION

It is a feature of the present invention to provide a system and a method which substantially overcomes the one or more of the above mentioned disadvantages.

It is the principal object of the present embodiment is to provide a system for collecting a dust flowing from a dust producing device or work arrangement with minimum filters and without the need of electric power and sensors.

Another object of the present embodiment is to provide the portable system for collecting the dust flowing from the one or more dust producing devices like Hand Blocks.

A portable system for collecting a dust from one or more dust producing machines is provided in accordance to the preferred embodiment herein. The portable system includes a compressed air generating unit for generating compressed air, a venturi unit which is configured to connect the compressed air generating unit and at least one of the one or more dust producing machines and a cyclone separator which is connected to the venturi unit. The venture unit creates a suction using the compressed air. The suction collects the dust from the one or more dust producing machines and mixes the compressed air and the dust. The cyclone separator receives the dust and the compressed air and releases the compressed air by separating the dust. The venturi unit includes one or more inlets and an outlet. A dust outlet duct of the one or more dust producing devices is connected to at least one inlet of the one or more inlets. The compressed air generating unit is connected to at least one inlet of the one or more inlets.

In another preferred embodiment, the portable system includes a coupler having one or more input ports and an output port and the dust outlet duct of the one or more dust producing machines is connected at least one of the plurality input ports. The output port of the coupler is connected to the at least one inlet of the one or more inlets present in the venturi unit. The portable system includes a dust tray. The cyclone separator includes a chamber having an inlet, and an outlet and the dust tray is connected to the bottom of the chamber. The inlet of the chamber is positioned at top and receives the dust along with the compressed air from the venturi unit. The dust may include coarse dust particles and fine dust particles. The coarse dust particles are collected in the dust tray due to centrifugal force and the fine dust particles along with the compressed air is travelled through the outlet. The portable system includes a filter which is connected to the outlet of the cyclone separator. The filter receives the fine dust particles along with the compressed air, filters the fine dust particles and releases the compressed air. In the preferred embodiment, the filter is a non-woven filter and the one or more dust producing machines is a dual action sander or a hand block. The compressed air generating unit, the one or more dust producing machines and the venturi unit are connected through flexible hoses or conduits. The compressed air generating unit is an air compressor.

### BRIEF DESCRIPTION OF THE ACCOMPANYING DRAWINGS

The advantages and features of the invention will become more clearly apparent from the following description which refers to the accompanying drawings given as non-restrictive examples only and in which:

FIG. 1 illustrates a typical dust collection system;

FIG. 2A illustrates a portable system for collecting a dust from one or more dust producing machines in accordance to preferred embodiment herein;

FIG. 2B illustrates the portable system shown in FIG. 2A for collecting a dust from one or more dust producing machines in accordance to preferred embodiment herein;

FIG. 3A illustrates the perspective view of the cyclone separator of FIG. 2A and FIG. 2B in accordance to the preferred embodiment herein;

FIG. 3B illustrates the cross sectional side view of the cyclone separator of FIG. 2A and FIG. 2B in accordance to the preferred embodiment herein; and

FIG. 3C illustrates the cross sectional top view of the cyclone separator of FIG. 2A and FIG. 2B in accordance to the preferred embodiment herein.

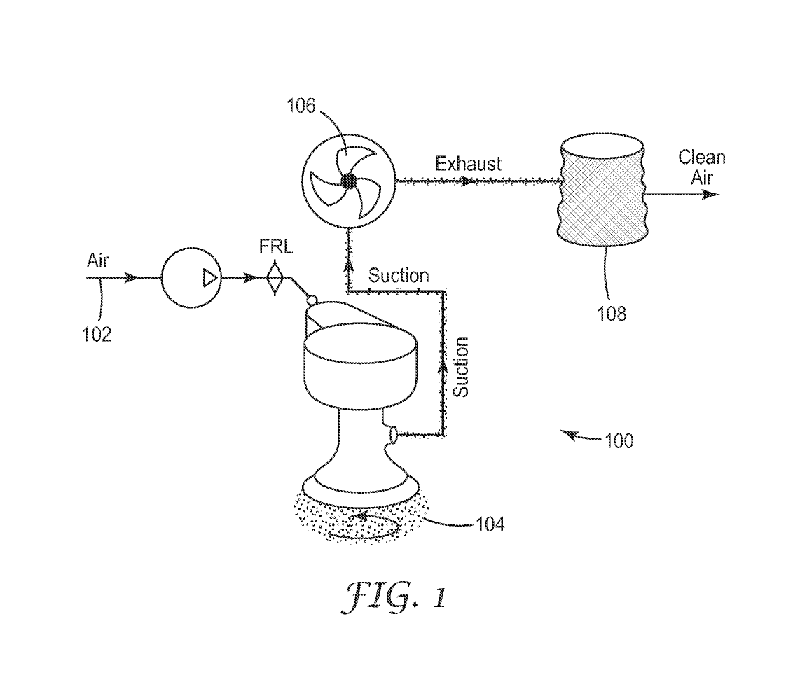

### DETAILED DESCRIPTION OF THE INVENTION

The present invention will be described herein below with reference to the accompanying drawings. A system for collecting a dust from the dust producing machine is described.

The following description is of exemplary embodiment of the invention only, and is not limit the scope, applicability or configuration of the invention. Rather, the following description is intended to provide a convenient illustration for implementing various embodiments of the invention. As will become apparent, various changes may be made in the function and arrangement of the structural/operational features described in these embodiments without departing from the scope of the invention as set forth herein. It should be appreciated that the description herein may be adapted to be employed with alternatively configured devices having different shaped, components, and the like and still fall within the scope of the present invention. Thus the detailed description herein is presented for purposes of illustration only and not of limitation.

The present embodiment provides a system for collecting a dust from the dust producing device, and more particularly, the portable system for collecting the dust flowing from the one or more dust producing machines with minimum filters and without the need of electric power and sensors. The dust producing device is referred herein and exemplified as a sander and a hand block in the figures. However, the dust producing device may comprise any device capable of operating similar to sander and/or hand block.

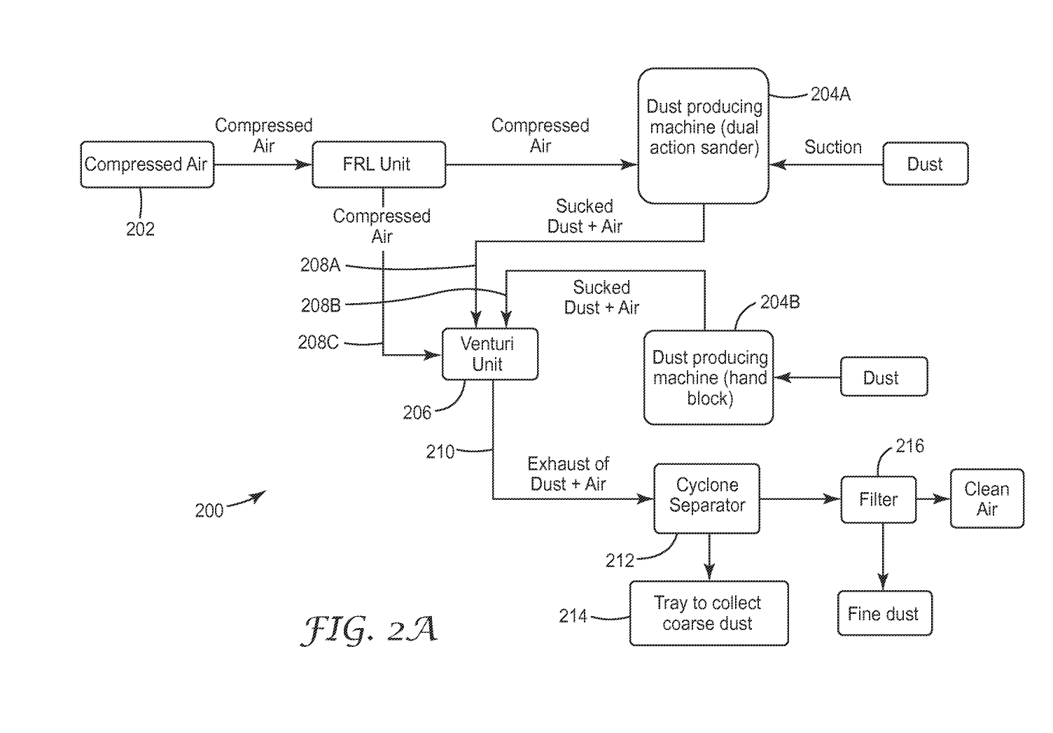

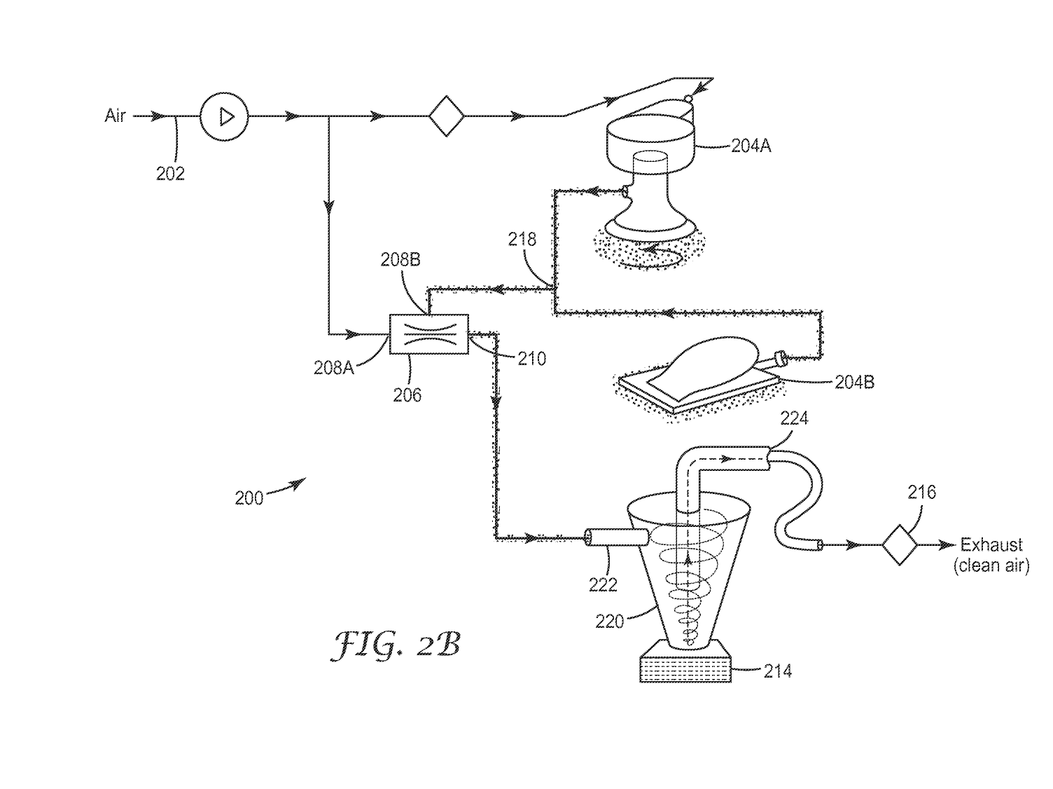

FIG. 2A illustrates a portable system 200 for collecting a dust from one or more dust producing machines 204A-B in accordance to the preferred embodiment herein. The portable system 200 includes a compressed air generating unit 202 for generating a compressed air, a venturi unit 204 and a cyclone separator 212. The compressed air generating unit 202 is an air compressor but not limited to any device which is capable of generating the compressed air. The venturi unit 204 is configured to include one or more inlets 208A-C and an outlet 210. A dust outlet duct of the one or more dust producing machines 204A-B is connected to a first inlet 208A and a second inlet 208B and the compressed air generating unit 202 is connected to a third inlet 208C. The venturi unit 206 creates a suction using the compressed air received from the compressed air generating unit 202 in the third inlet 208C. By using the venturi principle, the venturi unit 206 creates a vacuum in the range of 0.1-0.2 bar (10-20% vacuum), and thus eliminates the need of the use of electric motor for creating suction for collecting dust from the one or more dust producing machines 204A-B. The suction created in the venturi unit 206 used to collect the dust from the one or more dust producing machines 204A-B through the first inlet 208A and the second inlet 208B. The venturi unit 206 mixes the compressed air and the dust received in the first inlet 208A and the second inlet 208B.

The compressed air along with the dust enters the cyclone separator 212 through the outlet 210. The cyclone separator 212 is configured to separate the dust, collect the dust in a dust tray 214 and release the compressed air outside. The detailed design of the cyclone separator 212 is discussed later below. The dust may include coarse dust particles and a fine dust particle. The cyclone separator 212 separates the coarse dust particles present in the dust and collects the coarse dust particles in the dust tray 214. The compressed air along with the fine dust particles is released outside from the cyclone separator 212. The portable system 200 may also includes a filter 216 which is connected to the cyclone separator 212 to the filter 216. The filter 216 filters the fine dust particles and releases the compressed air. The filter 216 is a non-woven filter. In this preferred embodiment, the compressed air generating 202, the one or more dust producing machines 204A-B and the venturi unit are connected through the flexible hoses or conduits. The compressed air generating unit also connected to the at least one of the one or more dust producing devices or arrangement 204A-B.

FIG. 2B illustrates a portable system 200 for collecting a dust from one or more dust producing machines 204A-B in accordance to another preferred embodiment herein. The portable system 200 includes a coupler 218 which is positioned between the venturi unit 206 and the one or more dust producing machines 204A-B. The coupler 218 is configured to include one or more input ports and an output port. The one or more input ports are connected to the dust outlet duct of the one or more dust producing machines 204A-B. The output port of the coupler 218 is connected to the cyclone separator 212. The cyclone separator 212 includes a chamber 220. The chamber 220 includes an inlet 222 positioned at top and the outlet 224. The dust tray 214 is connected to the bottom of the chamber 220. The compressed air along with the dust enters to the chamber 220 through the inlet 222 positioned at the top tangentially. The stream is constrained to travel in a downward spiral and the coarse dust particles present in the dust is collected in the dust tray 214 due to centrifugal force. The fine dust particles of dust and the compressed air are travelled to the filter 216 through the outlet 224. The filter 216 filters the fine dust particles and releases the compressed air. The one or more dust producing machines 204A-B shown in FIG. 2A is a dual action sander machine 204A and the hand-block 204B but not limited to any machine which is operating similar to the dust producing machine 204A-B.

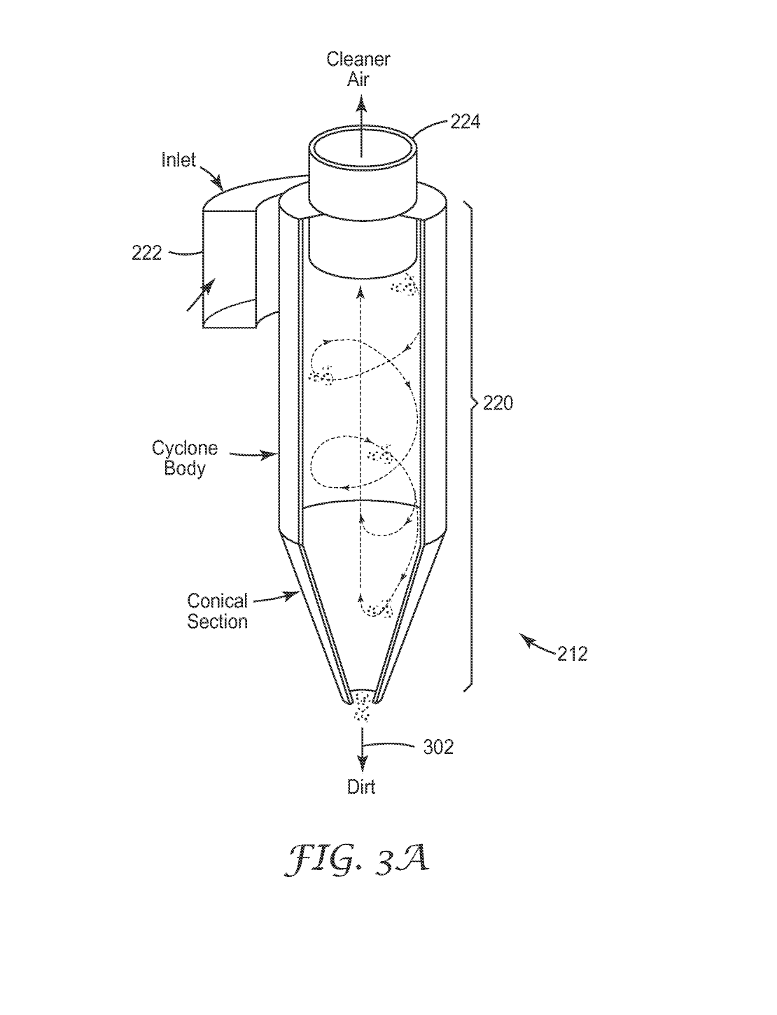

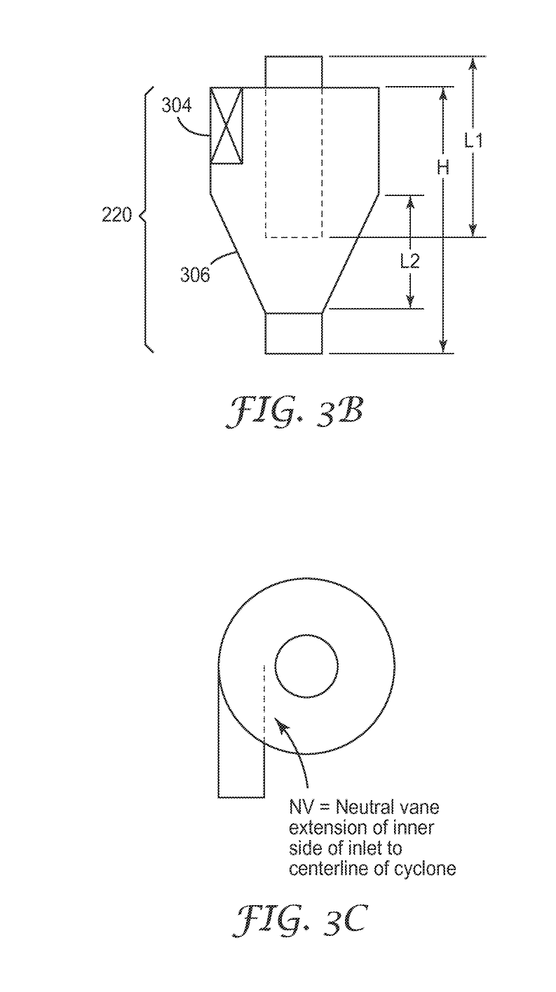

FIG. 3A illustrates the perspective view of the cyclone separator 212 of FIG. 2A and FIG. 2B in accordance to the preferred embodiment herein. The cyclone separator 212 includes the chamber 220, the inlet 222, the outlet 224 and a dirt outlet 302. FIG. 3B illustrates the cross sectional side view of the cyclone separator 212 of FIG. 2A and FIG. 2B in accordance to the preferred embodiment herein. The chamber 220 includes a main upper cylinder 304 and a lower cone 306. FIG. 3C illustrates the cross sectional top view of the cyclone separator of FIG. 2A and FIG. 2B in accordance to the preferred embodiment herein. The dust collection efficiency is the strong function of a dust particle size present in the dust and it increases with the increasing particle size. The compressed air along with the dust enters into the inlet 222 of the cyclone separator 212 and spins inside Ne revolutions in the outer vortex of the chamber 220 and entering into the inner vortex and passes upwards towards the outlet 224 of the chamber 220. The value of the Ne is derived from the following equation.

$$Ne = \frac{1}{H} [ L 1 + \frac{L 2}{2} ]$$

Where
L1—is the height of main upper cylinder
L2—is the height of lower cone
H—Height of inlet through which the compressed air along with the dust enters

The compressed air along with the dust enters the cyclone separator 212 and tends to move outwards through outlet 224 under the influence of centrifugal force. This is resisted by drag of dust particles (coarse dust particles and fine dust particles) present in the dust moving radically through the compressed air and the resultant terminal or radial velocity of the dust particles is found by equating the centrifugal and drag forces. To collect the dust particles in the dust tray 214 which is connected at the bottom of the cyclone separator 212, the dust particle must reach the outer wall before the compressed air leaves the outer vortex. The time and distance are both known quantities the time is the compressed air residence time, which depends on compressed air inlet velocity, radius of the cyclone separator 212 and the number of turns in the vortex. The maximum value of the distance to be travelled is the length from the inner edge of the inlet 222 to the outer wall. Assuming the laminar flow an expression is derived that relates the collection efficiency to the different cyclone parameters and operating conditions.

The present embodiment facilitates to provide the portable system 200 for collecting the dust from the one or more dust producing machines 204A-B without electricity. The portable system 200 does not require electrical power to operate. The portable system 200 uses venturi unit 206 that creates suction for collecting the dust from the one or more dust producing machines 204A-B. Thus facilities the user to operate the portable system 200 for many hours without interruption and fire hazard. The venturi unit 206 is configured to include the one or more inlets 208A-C which facilitates the user to connect the one or more dust producing machines 204A-B and operate simultaneously. In another preferred embodiment, the portable system 200 also includes the coupler 218 which also facilities the user to connect the one or more dust producing machines 204A-B to the venturi unit 206.

Several exemplary embodiments have thus been described. Modifications and alterations may occur to others upon reading and understanding the preceding detailed description. It is intended that the exemplary embodiments be construed as including all such modifications and alterations insofar as they come within the scope of the appended claims or the equivalents thereof.

1. A portable system (200) for collecting a dust from one or more dust producing machines (204A-B) comprising:
a compressed air generating unit (202) for generating compressed air;
a venturi unit (206) provided between said compressed air generating unit (202) and said one or more dust producing machines (204A-B), said venturi unit (206) capable of collecting and mixing dust from said one or more dust producing machines (204A-B) with said compressed air; and
a cyclone separator (212) connected to an outlet (210) of said venturi unit (206), to separate the dust from the mixture of dust and compressed air and release the compressed air.

2. The portable system (200) as claimed in claim 1, wherein said venturi unit (206) comprises one or more inlets (208A-B) and said outlet (210), wherein a dust outlet duct of said one or more dust producing machines (204A-B) is connected to at least one inlet of said one or more inlets (208A-B), and said compressed air generating unit (202) is connected to at least one inlet of said one or more inlets.

3. The portable system (200) as claimed in claim 2, comprising a coupler (218) having one or more input ports and an output port and said dust outlet duct of said one or more dust producing devices (204A-B) is connected at least one of said plurality input ports and said output port connected to said at least one inlet of said one or more inlets (218A-B).

4. The portable system as claimed in claim 1, wherein said cyclone separator (212) comprises
a chamber (220) having an inlet and an outlet, said inlet is positioned at top and said inlet receives said dust along with said compressed air from said venturi unit (206); and
a dust tray (214) which is connected at bottom of said cone shaped chamber (220);
wherein dust comprises a coarse dust particles and a fine dust particles, said coarse dust particles are collected in said dust tray (214) due to centrifugal force and said fine dust particles along with said compressed air is travelled through said outlet.

5. The portable system as claimed in claim 4, comprising a filter (216) which is connected to said outlet of said cyclone separator (212) and said filter (216) receives said fine dust particles along with said compressed air, filters said fine dust particles and releases said compressed air.

6. The portable system as claimed in claim 5, wherein said filter (216) is a non-woven filter.

7. The portable system as claimed in claim 1, wherein said one or more dust producing machines (204A-B) is a dual action sander or a hand block.

8. The portable system as claimed in claim 1, wherein said compressed air generating unit (202), said one or more dust producing devices (204A-B) and said venturi unit (206) are connected through flexible hoses or conduits.

9. The portable system as claimed in claim 1, wherein said compressed air generating unit is an air compressor.
